(19) United States
(12) Patent Application Publication
(10) Pub. No.: US 2011/0287741 A1
(43) Pub. Date: Nov. 24, 2011

(54) SECURE APPLICATION CONTROL IN MOBILE TERMINAL USING BIOMETRIC SENSOR

(76) Inventor: KRISHNANAND PRABHU, Bangalore (IN)

(21) Appl. No.: 12/782,550

(22) Filed: May 18, 2010

(51) Int. Cl. H04M 1/66

(52) U.S. Cl. 455/411

(57) ABSTRACT

An exemplary mobile terminal having a biometric input device, according to an embodiment of the present invention includes a biometric input device, configured to receive biometric input related to at least one physical attribute of a user and to authorize performance of an instruction by a processor based on the biometric input related to the at least one physical attribute. The mobile terminal also includes the processor, operatively coupled to the biometric input device and configured to receive the instruction from the biometric input device and to execute the instruction based on authorization by the biometric input device. The mobile terminal also includes a transceiver, operatively coupled to the processor, configured to send and receive at least one of a voice call and data.

### FIELD OF THE INVENTION

The invention relates in general to application control and more specifically to application control using a biometric sensor.

### BACKGROUND

Biometric identification has increasing popularity as means of security in many different technological areas. Fingerprint recognition is a biometric identification technique used to verify a person's identity by comparing a current swipe of the person's fingerprint against a reference swipe. Fingerprint sensors have been integrated into mobile phones for user identification and phone security. However, at present, secure applications are protected by a master PIN (personal identification number), usually a 4-digit number. Furthermore, secure applications are visible in the main menu or sub menu and are accessed by entering the PIN. Important information, such as contact information, SMS messages, e-mails, or folders containing sensitive documents cannot be hidden from other users of the phone, including unauthorized users. Using a PIN also has the problem that the PIN may be decoded. Additionally, secure applications are visible in one or more menus, and are viewable by other users including unauthorized users. Thus, increased utilization of biometric identification on mobile phones is needed for security reasons.

### SUMMARY

For example and without limitation, the mobile terminal (phone, mobile phone or mobile terminal apparatus) may utilize multiple fingers, each mapped to a different application, to biometrically control that application or feature.

An exemplary mobile terminal having a biometric input device, according to an embodiment of the present invention includes a biometric input device, configured to receive biometric input related to at least one physical attribute of a user and to authorize performance of an instruction by a processor based on the biometric input related to the at least one physical attribute. The mobile terminal also includes the processor, operatively coupled to the biometric input device and configured to receive the instruction from the biometric input device and to execute the instruction based on authorization by the biometric input device. The mobile terminal also includes a transceiver, operatively coupled to the processor, configured to send and receive at least one of a voice call and data.

In another embodiment, a mobile terminal having a biometric input device includes the biometric input device, configured to receive a separate fingerprint input for each of at least two fingers of a user and to authorize performance of a separate instruction by a processor based on each separate fingerprint input. The mobile terminal also includes the processor, operatively coupled to the biometric input device, configured to receive the separate instruction from the biometric input device and to execute the separate instruction based on authorization by the biometric input device. The mobile terminal also includes the transceiver, operatively coupled to the processor, configured to send and receive at least one of a voice call and data.

In another embodiment, a method in a mobile terminal includes receiving an establishing biometric input, enrolling the establishing biometric input by identifying the establishing biometric input with an application in the mobile terminal, and receiving a checking biometric input. The method also includes determining whether to authorize access to the application based on comparison of the checking biometric input against the establishing biometric input.

Thus, the user is provided with enhanced options for securing applications, personal folders, important e-mails, SMS messages, contacts and/or other information. Furthermore, the level of security is increased because an unauthorized user is unable to see or perceive that the application or information is present in the phone. Even if the phone is stolen, the secure applications are safely hidden from view and are only revealed and launched when the correct finger is swiped. Additionally, each application may have a unique finger mapped to it, enhancing customization and security.

### BRIEF DESCRIPTION OF THE DRAWINGS

FIG. 1 is a diagram that graphically depicts an exemplary embodiment of enrollment of fingerprints by a user to generate fingerprint templates to control different applications.

FIG. 2 is a block diagram illustrating an exemplary mobile terminal having a biometric input device, according to an embodiment of the present invention.

FIG. 3 is a flow diagram of a method in a mobile terminal, according to another embodiment of the invention.

FIG. 4 is a flow diagram of an exemplary method in a mobile terminal, according to another embodiment of the invention.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the invention. Furthermore, there is no intention to be bound by any expressed or implied theory presented in the preceding technical field, background, brief summary or the following detailed description. The present disclosure should be accorded scope consistent with the claims, and not limited to the examples described and shown herein.

Embodiments of the disclosure are described herein in the context of practical non-limiting applications, namely, application control in a mobile terminal using a biometric sensor. Embodiments of the disclosure, however, are not limited to such user application control, and the techniques described herein may also be utilized in other biometric sensor applications. For example, embodiments may be applicable to electronic game machines, digital music players, personal digital assistants (PDA), personal handy phone system (PHS), lap top computers, and the like. Furthermore, the embodiments of the disclosure are also not limited to controlling applications. Controlling data and other information is also contemplated.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

The following description is presented to enable a person of ordinary skill in the art to make and use the embodiments of the disclosure. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the embodiments of the present disclosure. Thus, the embodiments of the present disclosure are not intended to be limited to the examples described herein and shown, but are to be accorded the scope consistent with the claims.

In an embodiment, a biometrically-enabled mobile phone (mobile terminal or mobile terminal apparatus) includes a biometric sensor, such as a fingerprint sensor. The biometric sensor may be utilized to control various operations and to implement various features within the mobile phone, such as hiding or revealing secure applications, for example, but the embodiments are not so limited. For example, controlling data is also considered part of the embodiments.

In an embodiment, a user may enroll a fingerprint (fingerprint template) to control a phone operation. Furthermore, the user may enroll a different finger to control a different phone operation. Alternatively, the user may enroll a combination of fingers to control the different phone operation. The fingerprint templates may be stored securely. In one embodiment, a fingerprint template may be mapped to hide and/or reveal a secure application from user view in the main phone menu or other location. The application is revealed by swiping the enrolled or designated finger (master finger). Alternatively, a Personal Identification Number (PIN) or other code may be entered to reveal the application.

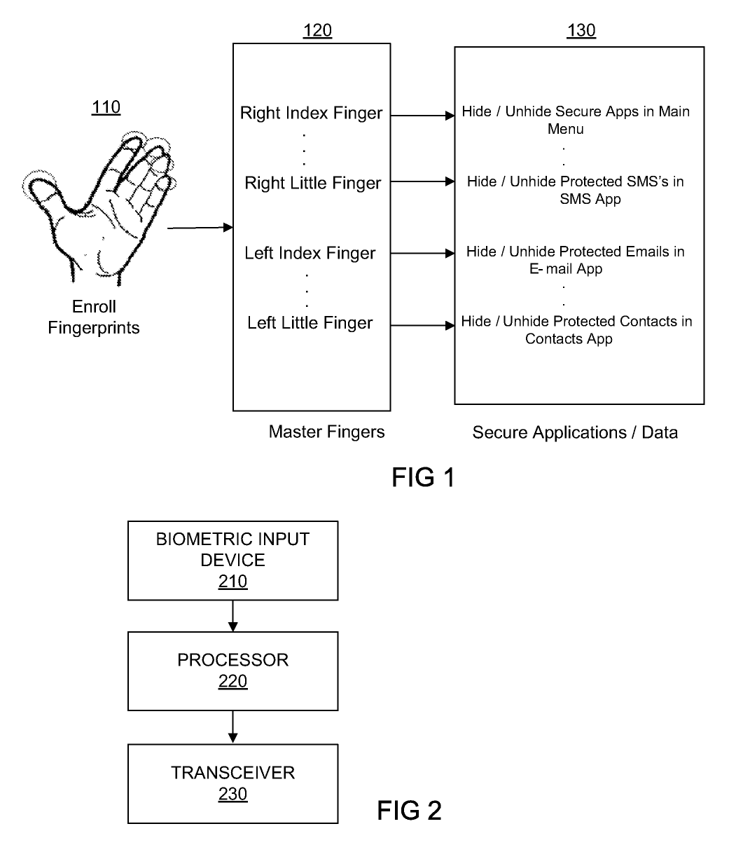

FIG. 1 depicts an exemplary embodiment of enrollment of fingerprints by a user to generate fingerprint templates to control different applications.

Referring to FIG. 1, at 110, a user's fingerprints are enrolled by swiping. At 120, the enrolled fingerprints are identified as master fingers. At 130, the master fingers are mapped to various applications, and may be used to control the applications, such as to secure and/or release security to the application.

Thus, for example and referring again to FIG. 1, a user enrolls his fingerprints for various applications. In this example, a fingerprint is enrolled and mapped or linked to a secure application so that the secure application may be hidden or revealed in a main menu view. Upon enrollment of the fingerprints, the user may configure one of the enrolled fingerprints, such as for example the right index finger to hide or reveal the secure applications from the user's view in the main menu. Accordingly, the right index finger is designated as the master finger to hide or reveal the secure application. Now in the main menu, the user may select an application, such as for example a contacts application to be hidden from a user or users. By this, the user may also prevent an unauthorized user of the phone from viewing the secured application, thereby enhancing security of the phone. Thus, upon swiping the right index finger in the main menu view, the contacts application may be hidden or revealed.

As such, a user may configure various applications to be hidden or revealed upon swiping of the correspondingly enrolled finger. Additionally, if an application is accessible from a secondary menu, or by pressing designated hotkeys, such an application may also be hidden or revealed by the swiping of the correspondingly enrolled finger.

Referring again to FIG. 1, the right little finger is enrolled and mapped to control a SMS (short messaging service) application. Accordingly, the SMS application has a slot for a master finger, and upon enrolling a finger or fingers, the user configures the right little finger as master finger for the SMS application, for example. The right little finger may then be used to control the SMS application, such as to hide or reveal the application from the user's view. Using this example, if the user wishes to hide a particular SMS message from another user or prevent unauthorized user of the phone, he may set the particular SMS message to be hidden from general view within the SMS application. This particular hidden SMS message is automatically revealed when user swipes the corresponding finger, in this example the right little finger. By swiping this finger again, the particular SMS message is hidden again. In this way, the user may configure multiple messages to be hidden and revealed upon swiping of the corresponding or master finger.

Thus, in one embodiment, an application may have one corresponding or master finger enrolled and mapped to it, such that by swiping this master finger the application may be controlled, for example one or more protected messages may be hidden or revealed. This technique may apply not only to SMS messages but also to other message types, such as e-mail messages, chats, tweets, as well as folders in the file manager application. The e-mail application and the file manager application, for example, would have different master fingers configured to them.

The techniques described herein are inherently secure as fingerprints are unique and the master fingerprint may be uniquely tied to a particular application. In the alternative, a single master finger may be assigned across multiple applications. For example, a single finger may be assigned as the master finger to hide or reveal secure applications, protected folders, protected SMS messages, e-mails and contacts. This approach provides greater simplicity, whereas uniquely assigning fingerprints to applications provides better customization and security.

FIG. 2 is a block diagram illustrating an exemplary mobile terminal having a biometric input device, according to an embodiment of the present invention.

Referring to FIG. 2, in one embodiment, the biometric input device 210 is configured to receive biometric input related to at least one physical attribute of a user and to authorize performance of an instruction by a processor based on the biometric input related to the at least one physical attribute. The physical attribute may be, for example, a fingerprint or a retinal scan. This physical attribute is tied uniquely to a biometric input by the biometric input device. Performance of an instruction by a processor 220 is authorized by evaluation of the biometric input by the biometric input device 210. The biometric input may be uniquely linked to a specific application. Thus, for example, a specific biometric input (a biometric input related to a specific physical attribute) may be required to hide or reveal a particular application, such as an email or photo application. However, the embodiments of the disclosure are not limited to controlling applications. Controlling data and other information is also contemplated.

The processor 220 is operatively coupled to the biometric input device and configured to receive the instruction from the biometric input device and to execute the instruction based on authorization by the biometric input device. The instruction may be, for example, to secure an SMS application.

A transceiver 230 is operatively coupled to the processor 230, and is configured to send and receive at least one of a voice call and data. This may include, for example, sending and receiving of emails, SMS messages and the like. Alternatively, in another embodiment, an equipment such as a personal digital assistant (PDA) or MP3 player includes the biometric input device 210 and the processor 220, and may not have the transceiver 230.

The biometric input device may include a biometric sensor selected from a fingerprint sensor, a retinal scanner, a handprint scanner, a facial recognition scanner, and a handwriting analyzer.

The biometric input device may receive biometric inputs related to at least two physical attributes and authorizes the processor to perform a separate instruction for each of the biometric inputs.

The mobile terminal may include applications, and a single physical attribute is mapped to a single application such that the single application may be controlled by a biometric input related to the single physical attribute by the instruction. The instruction may include whether to hide or reveal an application, such as whether to hide or reveal a single application related to a single biometric input. The application may be selected from an SMS application, an e-mail application, a payment application, a contacts application, a photo application, and a secure application, for example and without limitation. The instruction may include whether to hide or reveal a message in the single application where the message may be selected from an SMS message, an e-mail message, and a contact, for example and without limitation.

Referring again to FIG. 2, in another embodiment, a mobile terminal having a biometric input device includes the biometric input device 210, which is configured to receive a separate fingerprint input for each of at least two fingers of a user and to authorize performance of a separate instruction by a processor based on each separate fingerprint input. Thus, in this embodiment, each finger, for example is mapped to controlling of a separate application. For example, the left pointer finger may be mapped to hide and unhide an email application, while the right pointer finger is mapped to hide and unhide an SMS application and the right little finger (pinky finger) is mapped to hide and unhide a contacts application. By this way, multiple applications may be controlled quickly and securely. The processor 220 is operatively coupled to the biometric input device, and is configured to receive the separate instruction from the biometric input device and to execute the separate instruction based on authorization by the biometric input device. The transceiver 230 is operatively coupled to the processor, and is configured to send and receive at least one of a voice call and data.

Thus, the mobile terminal may include applications, and a single fingerprint input may be mapped to a single application such that the single application may be controlled by the single fingerprint input. Alternatively, a combination of multiple fingerprint inputs may be mapped to a single application such that the single application may be controlled by the combination of multiple fingerprint inputs.

The instruction provided to the processor 220 by the biometric input device 210 may include whether to allow or disallow access to an application within the mobile terminal. For example and without limitation, the instruction may include whether to hide or reveal the application within the mobile terminal. The application may be selected from an SMS application, an e-mail application, a payment application, a contacts application, a photo application, and a secure application. The message may be selected from an SMS message, an e-mail message, and a contact. Furthermore, folders may be hidden or revealed in a file manager application, for example.

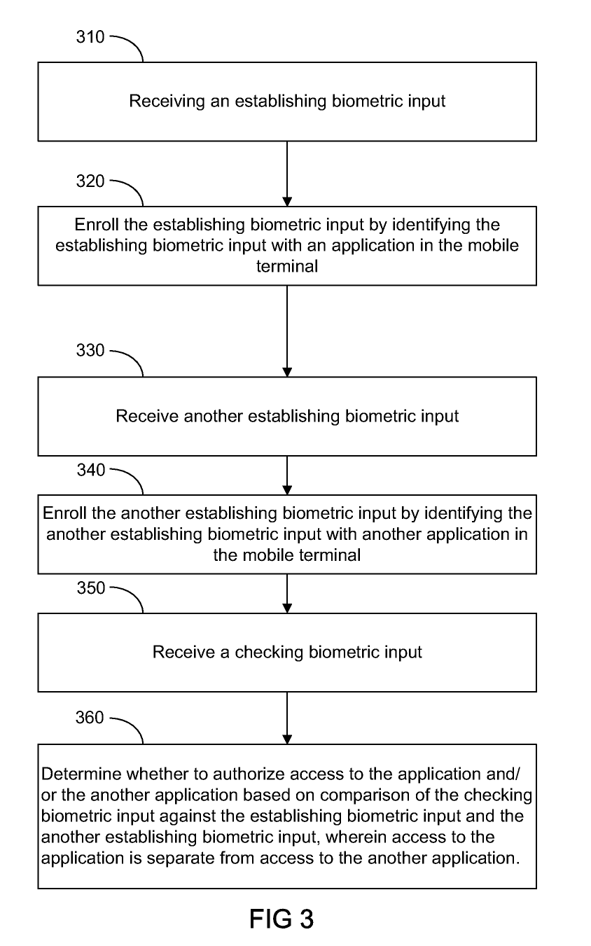

FIG. 3 is a flow diagram of a method in a mobile terminal, according to another embodiment of the invention.

Referring to FIG. 3, at 310 an establishing biometric input is received. At 320, the establishing biometric input is enrolled by identifying the establishing biometric input with an application in the mobile terminal. In other words, the establishing biometric input is enrolled and identified, mapped or associated with an application in the mobile terminal. At 330, another establishing biometric input is received. At 340, the another establishing biometric input is enrolled by identifying the another establishing biometric input with another application in the mobile terminal. At 350, a checking biometric input is received. At 360, it is determined whether to authorize access to the application and/or the another application based on comparison of the checking biometric input against the establishing biometric input and the another establishing biometric input, wherein access to the application is separate from access to the another application.

In another embodiment, a method in a mobile terminal includes receiving an establishing biometric input, enrolling the establishing biometric input by identifying the establishing biometric input with an application in the mobile terminal and/or identifying the establishing biometric input with an application in the mobile terminal, and receiving a checking biometric input. The method also includes determining whether to authorize access to the application based on comparison of the checking biometric input against the establishing biometric input.

The enrolling may, in one embodiment, be performed concurrently to designating the enrolled finger as a master finger. In this embodiment, the term ‘enrolling’ may be used more generally to also include mapping of the master finger to an application, for example.

The method may also include revealing the application based on the determining of whether to authorize access to the application. The method may also include receiving another establishing biometric input, and enrolling the another establishing biometric input by identifying the another establishing biometric input with another application in the mobile terminal. Each of the establishing biometric input and the another establishing biometric input may be used to authorize access to at least one separate application. The method may further include maintaining a hidden status of the application if access is not authorized. In one aspect, unauthorized users are prevented from enrolling a finger by a PIN code.

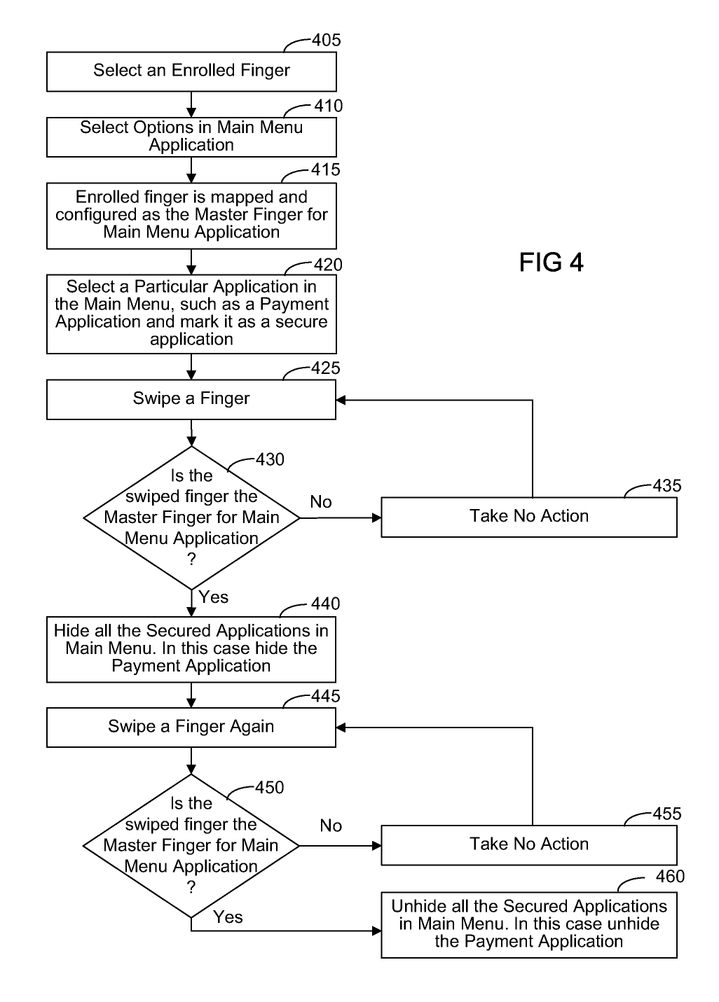

FIG. 4 is a flow diagram of an exemplary method in a mobile terminal, according to another embodiment of the invention. In this exemplary method, a secure application is controlled using a finger swipe on a biometric input device, after the corresponding finger has been enrolled.

Referring to FIG. 4, At 405, an enrolled finger is selected. At 410, options in a main menu application are selected. At 415, the enrolled finger is mapped as the master finger for the main menu application. At 420, a particular application in the main menu, such as a payment application is selected and marked as a secure application.

At 425, a finger is swiped. At 430, a determination is made of whether the swiped finger is the master finger for the selected main menu application. At 435, if the determination is negative, no action is taken, and the system prepares for another finger swipe. If the determination is positive, at 440 the secured application(s), in this example the payment application, are hidden.

At 445, a finger is swiped again. At 450, a determination is made of whether the swiped finger is the master finger for the selected main menu application. At 455, if the determination is negative, no action is taken, and the system prepares for another finger swipe. If the determination is positive, at 460 the secured application(s), in this example the payment application, are unhidden (revealed).

Referring again to FIG. 4, in other words and for exemplary purposes only, the user first selects an enrolled finger. This enrolled finger is mapped and configured as the Master finger in the options within the main menu. An application in the main menu may now be selected and marked as a secure application. The payment application is used in this example. Once the application is thus secured, the user can hide the application by simply swiping the master finger within the main menu. The application now becomes hidden and cannot be accessed or even seen by other and/or unauthorized users of the phone. To unhide the secure applications, the authorized user simply swipes the master finger again in the main menu. Alternatively, the secure applications can be unhidden by entering a master pin or code in the options within the main menu.

As a further example, a master finger may be more specifically mapped to an SMS application. The user first selects an enrolled finger. This enrolled finger is mapped and configured as the master finger in the options within the SMS application. Particular message(s) within the SMS application may then be selected and marked as a protected message(s). Once the message(s) are thus protected, the user may hide the protected message(s) by simply swiping the master finger within the SMS application. The message(s) now becomes hidden and may not be accessed or even seen by other and/or unauthorized users of the phone. To unhide the protected message(s), the authorized user simply swipes the master finger again in the SMS application.

It shall be understood by those of ordinary skill in the art that the term ‘application’ should be construed broadly to also include any other sort of computer program, such as for example an applet or a widget, without limitation. Furthermore, hiding and revealing of applications is not limited to the applications described above, but may also include, for example, the hiding and revealing of video clips recorded from a video calling application. Additionally, it will be understood by those of ordinary skill in the art that the embodiments of the invention are not limited to controlling certain message types (such as email), but include any type of user data in the mobile terminal. Furthermore, the operation of the mobile terminal may also include hiding and revealing of folders in a file manager application.

While at least one exemplary embodiment has been presented in the foregoing detailed description, the present disclosure is not limited to the above-described embodiment or embodiments. Variations may be apparent to those skilled in the art. In carrying out the present disclosure, various modifications, combinations, sub-combinations and alterations may occur in regard to the elements of the above-described embodiment insofar as they are within the technical scope of the present disclosure or the equivalents thereof. The exemplary embodiment or exemplary embodiments are examples, and are not intended to limit the scope, applicability, or configuration of the disclosure in any way. Rather, the foregoing detailed description will provide those skilled in the art with a template for implementing the exemplary embodiment or exemplary embodiments. It should be understood that various changes can be made in the function and arrangement of elements without departing from the scope of the disclosure as set forth in the appended claims and the legal equivalents thereof. Furthermore, although embodiments of the present disclosure have been described with reference to the accompanying drawings, it is to be noted that changes and modifications may be apparent to those skilled in the art. Such changes and modifications are to be understood as being comprised within the scope of the present disclosure as defined by the claims.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

Other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A mobile terminal having biometric input device, comprising:
the biometric input device, configured to receive biometric input related to at least one physical attribute of a user and to authorize performance of an instruction by a processor based on the biometric input related to the at least one physical attribute;
the processor operatively coupled to the biometric input device, configured to receive the instruction from the biometric input device and to execute the instruction based on authorization by the biometric input device; and
a transceiver operatively coupled to the processor, configured to send and receive at least one of a voice call and data.

2. The mobile terminal according to claim 1, wherein the biometric input device comprises a biometric sensor selected from at least one of the group consisting of:
a fingerprint sensor;
a retinal scanner;
a handprint scanner;
a facial recognition scanner; and
a handwriting analyzer.

3. The mobile terminal according to claim 1, wherein the biometric input device receives biometric inputs related to at least two physical attributes and authorizes the processor to perform a separate instruction for each of the biometric inputs.

4. The mobile terminal according to claim 3, wherein the mobile terminal comprises applications, and a single physical attribute is mapped to a single application such that the single application may be controlled by a biometric input related to the single physical attribute by the instruction.

5. The mobile terminal according to claim 1, wherein the instruction comprises whether to hide or reveal an application.

6. The mobile terminal according to claim 4, wherein the instruction comprises whether to hide or reveal the single application.

7. The mobile terminal according to claim 6, wherein the single application is selected from the group consisting of:
an SMS application;
an e-mail application;
a payment application;
a photo application;
a contacts application; and
a secure application.

8. The mobile terminal according to claim 6, wherein the instruction comprises whether to hide or reveal a message in the single application; the message selected from the group consisting of:
an SMS message;
an e-mail message; and
a contact.

9. A mobile terminal having biometric input device, comprising:
the biometric input device, configured to receive a separate fingerprint input for each of at least two fingers of a user and to authorize performance of a separate instruction by a processor based on each separate fingerprint input;
the processor operatively coupled to the biometric input device, configured to receive the separate instruction from the biometric input device and to execute the separate instruction based on authorization by the biometric input device; and
a transceiver operatively coupled to the processor, configured to send and receive at least one of a voice call and data.

10. The mobile terminal according to claim 9, wherein the mobile terminal comprises applications, and a single fingerprint input is mapped to a single application such that the single application may be controlled by the single fingerprint input.

11. The mobile terminal according to claim 9, wherein mobile terminal comprises applications, and a combination of multiple fingerprint inputs is mapped to a single application such that the single application may be controlled by the combination of multiple fingerprint inputs.

12. The mobile terminal according to claim 9, wherein the instruction comprises whether to allow or disallow access to an application within the mobile terminal.

13. The mobile terminal according to claim 12, wherein the instruction comprises whether to hide or reveal the application within the mobile terminal.

14. The mobile terminal according to claim 10, wherein the applications are selected from the group consisting of:
an SMS application;
an e-mail application;
a payment application;
a photo application;
a contacts application; and
a secure application.

15. The mobile terminal according to claim 14, wherein the instruction comprises whether to hide or reveal a message in the single application; the message selected from the group consisting of:
an SMS message;
an e-mail message; and
a contact.

16. A method in a mobile terminal, comprising:
receiving an establishing biometric input;
enrolling the establishing biometric input by identifying the establishing biometric input with an application in the mobile terminal;
receiving a checking biometric input; and
determining whether to authorize access to the application based on comparison of the checking biometric input against the establishing biometric input.

17. The method according to claim 16, further comprising revealing the application based on the determining of whether to authorize access to the application.

18. The method according to claim 16, further comprising:
receiving another establishing biometric input;
enrolling the another establishing biometric input by identifying the another establishing biometric input with another application in the mobile terminal.

19. The method according to claim 18, wherein each of the establishing biometric input and the another establishing biometric input are used to authorize access to at least one separate application.

20. The method according to claim 17, further comprising maintaining the application in a hidden status if access is not authorized.
